(19) United States
(12) Patent Application Publication
(10) Pub. No.: US 2007/0150308 A1
(43) Pub. Date: Jun. 28, 2007

(54) Healthcare management system

(75) Inventor: Syamala Srinivasan, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/315,284

(22) Filed: Dec. 23, 2005

(51) Int. Cl. G06Q 10/00

(52) U.S. Cl. 705/2

(57) ABSTRACT

A healthcare management system is provided. The system may include a memory configured to store health-related information about individual members of a population and a processor operatively coupled to the memory. The processor may be configured to select a first treatment intervention for addressing predetermined symptoms of an individual member of the population from two or more potential treatment interventions. The processor may be configured to select the first treatment intervention based on information stored in the memory, such as a determined risk that the symptoms are caused by one or more predetermined health conditions. In addition, the processor may be configured to select the first treatment intervention based on at least one of the following factors: a success rate of each potential treatment intervention at treating the one or more predetermined health conditions; and a cost of each potential treatment intervention. The system may also include an output module configured to provide information regarding the first treatment intervention to at least one of a healthcare provider and an insurer of the individual member.

### TECHNICAL FIELD

The present disclosure is directed to the field of healthcare and, more particularly, to a healthcare management system.

### BACKGROUND

Healthcare costs have been rising at a staggering rate over the past two decades. In response, individuals, businesses, and insurance carriers have been seeking ways to lower healthcare costs. For instance, the rise in the use of health maintenance organizations (HMO's) is one attempt to gain control of the costs of healthcare.

While controlling costs is one way to reduce the costs of healthcare, one of the best ways to reduce the costs of healthcare is to reduce the demand for healthcare by maintaining and improving the health of members of a targeted population of people. Not only does this reduce the costs of healthcare for the insurer and those paying premiums, but it also increases the quality of life for those whose health is improved in the process. The life expectancy and quality of life of population members may be improved by helping individuals gain the knowledge, motivation, and opportunities they need to make informed decisions about their health, and/or by reinforcing healthy medical practices and lifestyles.

Thus, a comprehensive health promotion/disease prevention program can reduce demand-side costs. Such a comprehensive program may include the following components: customized self-care books and newsletters for the targeted population; tracking of health needs; segmentation of the population into risk cohorts; individualized interventions; incentives to maximize participation; integration with existing healthcare programs, such as employee assistance programs; and health exams. In addition, a comprehensive program may also include health risk assessment questionnaires to facilitate monitoring of important healthcare factors. Such questionnaires may administer targeted questions to individual members of the targeted population. A comprehensive program may further include dissemination of packages of health-related information. Such packages may include feedback regarding answers submitted in response to health risk assessment questionnaires.

Preventable illness and its associated costs make up a large percentage of the burden on the healthcare system. Preventable causes of illness, led by cigarette smoking, lack of exercise, and poor diet, represent many of the leading causes of death in the U.S. Self-efficacy, the confidence gained by accepting accountability for one's lifestyle choices, can be an essential prerequisite for subsequent changes in health behaviors. Researchers and experts have shown that appropriate healthcare utilization is linked to the presence or absence of personal self-efficacy and to the availability of well-presented information. Dissemination of health risk assessment questionnaires and health-related information can be substantial factors in achieving self-efficacy.

Systems have been developed for selecting interventions. For example, U.S. Patent Application Publication No. 2003/0135391, filed by Edmundson et al. and published on Jul. 17, 2003 (“the '391 publication”), discloses such a system. The '391 publication discloses selecting an intervention to prevent a health condition for which an individual is at risk. The '391 publication also discloses selecting an intervention to treat a health condition which is readily diagnosable in an individual.

While the '391 publication may be configured to select interventions to prevent conditions or to treat readily diagnosable conditions, one or more improvements could be made to the system of the '391 publication. For example, a healthcare management system could be configured to select interventions for treating individuals who present with early symptoms related to a condition that is not readily diagnosable at such an early stage

The present disclosure is directed to improvements in existing healthcare management systems.

### SUMMARY OF THE INVENTION

In one aspect, the present disclosure is directed to a healthcare management system. The system may include a memory configured to store health-related information about individual members of a population and a processor operatively coupled to the memory. The processor may be configured to select a first treatment intervention for addressing predetermined symptoms of an individual member of the population from two or more potential treatment interventions. The processor may be configured to select the first treatment intervention based on information stored in the memory, such as a determined risk that the symptoms are caused by one or more predetermined health conditions. In addition, the processor may be configured to select the first treatment intervention based on at least one of the following factors: a success rate of each potential treatment intervention at treating the one or more predetermined health conditions; and a cost of each potential treatment intervention. The system may also include an output module configured to provide information regarding the first treatment intervention to at least one of a healthcare provider and an insurer of the individual member.

In another aspect, the present disclosure is directed to a method of healthcare management. The method may include selecting a first treatment intervention for addressing predetermined symptoms of an individual member of the population from two or more potential treatment interventions. The first treatment intervention may be selected based on information stored in a memory, such as a determined risk that the symptoms are caused by one or more predetermined health conditions. In addition, the first treatment intervention may be selected based on at least one of the following factors: a success rate of each potential treatment intervention at treating the one or more predetermined health conditions; and a cost of each potential treatment intervention. The method may also include providing information regarding the first treatment intervention to at least one of a healthcare provider and an insurer of the individual member.

In another aspect, the present disclosure is directed to a computer-readable medium having stored thereon machine executable instructions for healthcare management. The instructions may include the steps of selecting a first treatment intervention for addressing predetermined symptoms of an individual member of the population from two or more potential treatment interventions. The selection may be based on information stored in a memory, such as a determined risk that the symptoms are caused by one or more predetermined health conditions. Additionally, the selection may be based on at least one of the following factors: a success rate of each potential treatment intervention at treating the one or more predetermined health conditions; and a cost of each potential treatment intervention. The computer-readable medium may further include instructions for providing information regarding the first treatment intervention to at least one of a healthcare provider and an insurer of the individual member.

### BRIEF DESCRIPTION OF THE DRAWINGS

FIG. 1 illustrates a health and wellness guidance system according to an exemplary disclosed embodiment.

FIG. 2 illustrates different types of health-related information stored in a database according to an exemplary disclosed embodiment.

FIG. 3 is a block diagram illustrating an exemplary method of processing information according to an exemplary disclosed embodiment.

### DETAILED DESCRIPTION

Reference will now be made in detail to the drawings. Wherever possible, the same reference numbers will be used throughout the drawings to refer to the same or like parts.

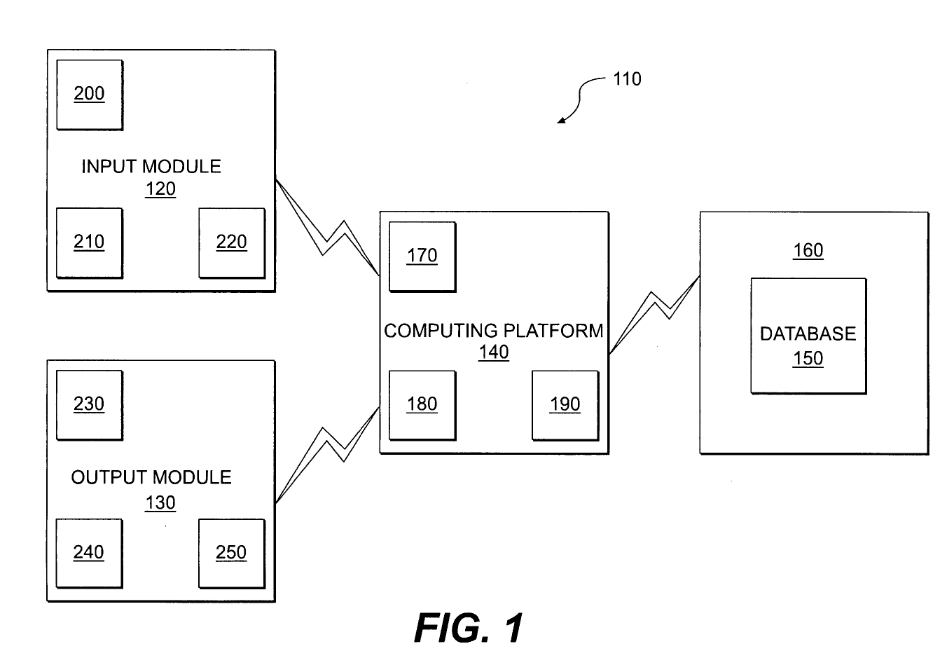

FIG. 1 illustrates a healthcare management system 110. System 110 may include an input module 120, an output module 130, and a computing platform 140. Computing platform 140 may include or may be otherwise operatively coupled to a database 150, which may be stored in a memory 160. Database 150 may include more than one database or other type of electronic repository. Computing platform 140 may be adapted to include the necessary functionality and computing capabilities to implement health risk assessment (HRA) strategies input through input module 120 and access, read, and write to database 150. The results of analyzing data may be provided as output from computing platform 140 to output module 130 for printed display, viewing, and/or further communication to other system devices. Such output may include, for example, one or more questionnaires or information packages. Output from computing platform 140 can also be provided to database 150, which may be utilized as a storage device for health-related information about individual members of a population.

In the embodiment of FIG. 1, computing platform 140 may include a PC or mainframe computer configured to perform various functions and operations. Computing platform 140 may be implemented, for example, by a general purpose computer selectively activated or reconfigured by a computer program stored in the computer, or may be a specially constructed computing platform for carrying out the features and operations of system 110. Computing platform 140 may also be implemented or provided with a wide variety of components or subsystems including, for example, one or more of the following: a processor 170, a co-processor 180, a register 190, and/or other data processing devices and subsystems. Computing platform 140 may also communicate or transfer HRA strategies, questionnaires, and feedback to and/or from input module 120 and output module 130 through the use of direct connections or communication links, as illustrated in FIG. 1. In an exemplary embodiment, a firewall may prevent access to the platform by unauthorized outside entities.

Alternatively, communication between computing platform 140 and module 120 and module 130 can be achieved through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. By using dedicated communication links or a shared network architecture, computing platform 140 may be located in the same location or at a geographically distant location from input module 120 and/or output module 130.

Input module 120 may include a wide variety of devices to receive and/or provide the data as input to computing platform 140. As illustrated in FIG. 1, input module 120 may include an input device 200, a storage device 210, and/or a network interface 220. Input device 200 may include a keyboard, mouse, touchscreen, disk drive, video camera, magnetic card reader, or any other suitable input device for providing customer data to computing platform 140. Memory 160 may be implemented with various forms of memory or storage devices, such as read-only memory (ROM) devices and random access memory (RAM) devices. Storage device 210 may include a memory tape or disk drive for reading and providing data on a storage tape or disk as input to computing platform 140. Network interface 220 may be configured to receive data over a network (such as a LAN, WAN, intranet or the Internet) and to provide the same as input to computing platform 140. For example, network interface 220 may be connected to a public or private database over a network for the purpose of receiving information about members of the population from computing platform 140.

Output module 130 may include a display 230, a printer device 240, and/or a network interface 250 for receiving the results provided as output from computing platform 140. As indicated above, the output from computing platform 140 may include one or more questionnaires or information packages. The output from computing platform 140 may be displayed or viewed through display 230 (such as a CRT or LCD) and printer device 240. If needed, network interface 250 may also be configured to facilitate the communication of the results from computing platform 140 over a network (such as a LAN, WAN, intranet or the Internet) to remote or distant locations for further analysis or viewing.

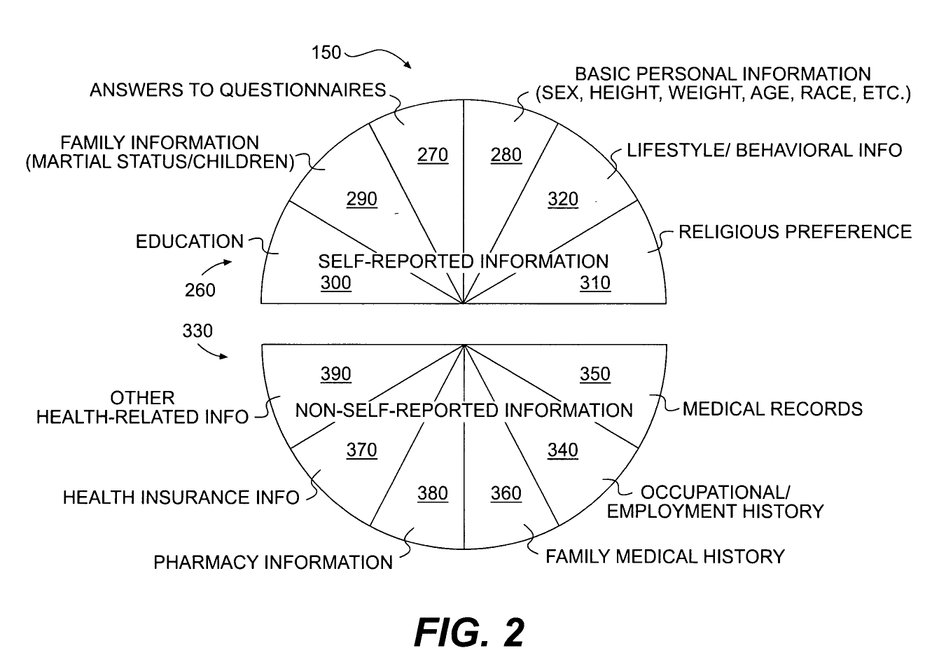

Health-related information may be stored in memory 160 in database 150. FIG. 2 illustrates one embodiment of database 150. Database 150 may include health-related information for a population of individuals. Database 150 may also include data for the population as a whole and/or selected portions of the population. Database 150 may further include individual health-related data for individual members of the population. Such individual data may include various information that may impact or otherwise relate to health-related issues. For example, database 150 may include self-reported information 260, which may be furnished by the individual members themselves. Self-reported information 260 may include information submitted by the individual members, for example, by filling out initial hiring paperwork for a particular employer. Alternatively or additionally, self-reported-information 260 may include information submitted through answers to or results of questionnaires (section 270).

Other types of self-reported information may include, for example, demographics, such as basic personal information like sex, height, weight, age, race, etc. (section 280) and/or family information such as marital status and information about the children of the individuals (section 290). Self-reported-information 260 may also include other demographics, such as information about the education of the individual members (section 300), religious preference (section 310), and/or any other personal information that may be affected by or have an affect on a health-related issue. Further, self-reported-information 260 may include lifestyle and/or behavioral information (section 320). Examples of health-related lifestyle and/or behavioral information may include information about whether the individual is a smoker or drinks alcohol, their sleep habits, diet, the geographic location and/or climate in which they reside, whether or not they engage in certain kinds of activities (e.g., sports, hiking, parachuting, scuba diving, etc.), and any other lifestyle or behavioral information that may be health-related.

Database 150 may also include non-self-reported information 330. Examples of non-self-reported information 330 may include information about an individual's occupational/employment history (section 340), medical records (section 350), and/or family medical history (section 360). Non-self-reported-information 260 may also include health insurance information (section 370), as well as pharmacy information (section 380). Such pharmacy information may include, for example, information about what prescriptions an individual member has taken (e.g., pharmacy records). Non-self-reported-information may include data such as medical claims data and/or pharmacy data.

It is within the scope of the present system to include any other type of health-related information in database 150 (section 390). Further, it should be noted that, while certain types of information have been discussed here as being examples of self-reported or non-self-reported, any type of information may be submitted in either manner. For example, an individual's marital status could be non-self-reported (e.g., obtained from another source, such as tax records). Similarly, although previously discussed as being non-self-reported, an individual's family medical history may be self-reported (e.g., through a survey).

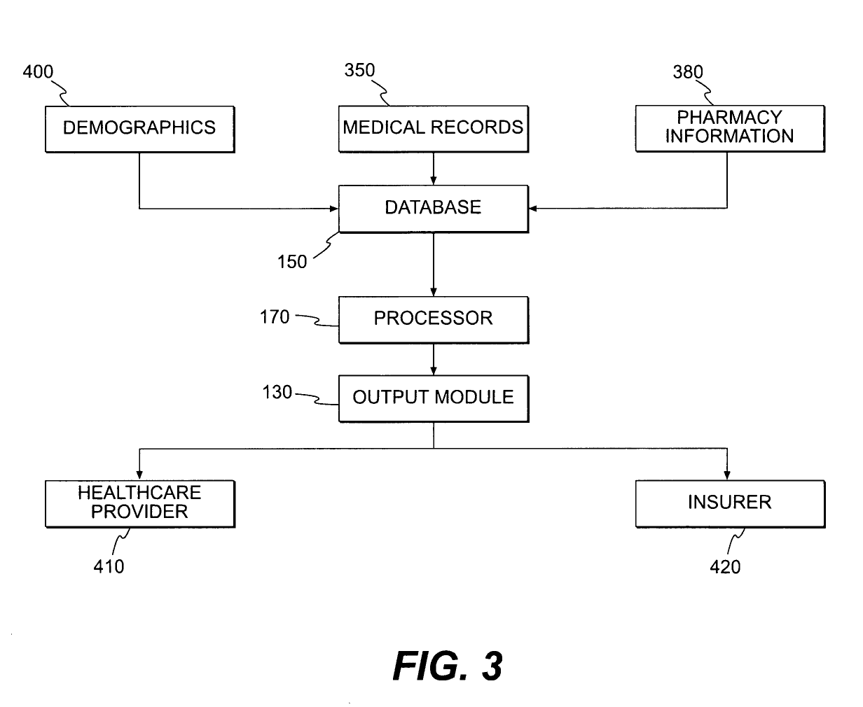

As illustrated in FIG. 3, system 110 may be configured to access, download, or otherwise gather various types of information from one or more sources. For example, information such as demographics 400, medical records 350, and pharmacy information 380, may be stored in database 150. An exemplary source of demographics 400 may include Fidelity Workplace Services. Exemplary sources of medical records 350 may include United Healthcare (UHC), Medstat, etc. An exemplary source of pharmacy information 380 may include Restat. System 110 may be configured to obtain information from these and/or other databases, which may be either public or private.

Processor 170 may be configured to analyze the information in database 150. Output module 130 may be configured to forward information such as data and/or analysis of such data to one or more entities external to system 110. For example, output module 130 may be configured to forward information to a healthcare provider 410 and/or an insurer 420 of an individual member of the population.

Non-self-reported information 330 and self-reported information 260 may be gathered and/or analyzed periodically. For example, the analysis may occur with any frequency including cycles that occur so frequently that they amount to real-time data analysis. For purposes of this disclosure, the term “real-time” shall refer to the immediate or substantially immediate availability of data to an information system as a transaction or event occurs. That is, data may be retrieved and available for analysis as quickly as it can be transmitted. Such transmissions may be virtually instantaneous or may take a few seconds or minutes to complete.

System 110 may be configured to determine, as part of the analysis of information in database 150, a risk that an individual member has of having or developing one or more predetermined health conditions. System 110 may be configured to administer tailored information packages and/or tailored questionnaires to members who are determined to be at risk for a particular condition. System 110 may be configured to send tailored information packages and/or tailored questionnaires to members whose risk exceeds a predetermined amount. For example, system 110 may be configured to send tailored information to an individual if the risk of them developing heart disease is greater than 30%.

Processor 170 may be configured to select a first treatment intervention for addressing predetermined symptoms of an individual member of the population from two or more potential treatment interventions. Processor 170 may be configured to select the first treatment intervention based on information stored in memory 160. The information on which the selection is based may include a determined risk that the symptoms are caused by one or more predetermined health conditions. For example, if a patient presents with chest pains, and they are above a particular age and have a family history of heart disease, then their high risk of developing heart disease themselves may prompt processor 170 to select a more aggressive initial intervention, rather than waiting to more definitively diagnose their condition. In this case, a more aggressive initial intervention may include, for example an ECG and/or Nitroglycerin rather than an antacid to relieve or rule out indigestion.

The selection may also be based on a success rate of each potential treatment intervention at treating the one or more predetermined health conditions and/or a cost of each potential treatment intervention. Processor 170 may be configured to prioritize the cost of each potential treatment intervention over the success rate. Alternatively processor 170 may be configured to prioritize the success rate of each potential treatment intervention over the cost.

Processor 170 may also be configured to select a second treatment intervention from the two or more potential treatment interventions. The selection of the second treatment intervention may be based on the determined risk, the cost, and the success rate, wherein the cost and the success rate of each potential treatment intervention are prioritized differently than for selection of the first treatment intervention. In one embodiment, the first treatment intervention may be selected in such a manner where the cost may be weighted more heavily than the success rate.

For example, a first potential treatment intervention may have a 60% success rate, whereas a second potential treatment intervention may have a 65% success rate, but cost twice as much as the first potential success rate. In such a case, processor 170 may be configured to select the first potential success rate because the minimally higher success rate of the second potential treatment intervention may not justify its substantially higher cost. In selecting a second treatment intervention, processor 170 may be configured to select the second potential treatment intervention. In this way, processor 170 may be configured to determine treatment interventions optimized for different variables. In this case, the first selected treatment intervention may be optimal when cost is of highest priority. Conversely, the second selected treatment intervention may be optimal when success rate or overall effectiveness is of highest priority. In some embodiments, such information may be conveyed to one or more entities to enable them to choose which they prefer based on their own priorities.

Processor 170 may be further configured to select a preventative intervention for an individual member of the population from two or more potential preventative interventions to address one or more health conditions prior to detection of any symptoms of the one or more health conditions in the individual member. Processor 170 may be configured to select the preventative intervention based on information stored in memory 160. In some embodiments, such information may include a determined risk that the individual member may experience at least one of the one or more health conditions. For example, one or more preventative interventions such as aspirin therapy or a particular diet may be recommended for an individual who has a family history of heart disease even before they present with any symptoms of heart disease (e.g., chest pain, high blood pressure, high cholesterol, etc.).

In addition, the information stored in memory 160 on which processor 170 may base the selection may include a success rate of each potential preventative intervention at treating the one or more health conditions and/or a cost of each potential preventative intervention. Processor 170 may be configured to prioritize the cost and success rate of each potential preventative intervention relative to one another. A second preventative intervention may also be selected in a similar manner as the second treatment intervention.

Output module 130 may be configured to provide information regarding the first treatment intervention, the second treatment intervention, the preventative intervention, and/or the second preventative intervention to at least one of a healthcare provider and an insurer of the individual member. System 110 may be configured to maintain a record of what information and/or questions are administered to an individual. System 110 may be configured to store such data for purposes of analyzing the success of different interventions. Such data may also be used for, among other things, determining healthcare costs.

The foregoing description of exemplary disclosed embodiments has been presented for purposes of illustration and description. It is not exhaustive and does not limit the invention to the precise form disclosed. Modifications and variations are possible in light of the above teachings or may be acquired from practicing of the disclosed system. For example, the described implementation may include a particular network configuration but embodiments of the present disclosure may be implemented in a variety of data communication network environments using software, hardware, or a combination of hardware and software to provide the processing functions.

Those skilled in the art will appreciate that all or part of systems and methods consistent with the present disclosure may be stored on or read from other computer-readable media. System 110 may include a computer-readable medium having stored thereon machine executable instructions for performing, among other things, the methods disclosed herein. Exemplary computer readable media may include secondary storage devices, like hard disks, floppy disks, and CD-ROM; a carrier wave received from the Internet; or other forms of computer-readable memory, such as read-only memory (ROM) or random-access memory (RAM). Such computer-readable media may be embodied by one or more components of system 110, such as, for example, computing platform 140, database 150, memory 160, processor 170, or combinations of these and/or other components.

Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described above for each module, script, and daemon. For example, it is contemplated that these programs modules may be implemented using commercially available software tools, using custom object-oriented code written in the C++ programming language, using applets written in the Java programming language, or may be implemented as with discrete electrical components or as one or more hardwired application specific integrated circuits (ASIC) custom designed for this purpose.

The questionnaires and/or health-related information packages may include paper documents, electronic documents, Internet-based documents, and any other suitable media for documentation. The packages may include paper or paper-like documents, such as pamphlets. Alternatively or additionally, the packages may include electronic documents, such as computer files. Such files may be administered to members of the population via various modes of transmission, such as email. Internet-based documents may include word processor type files and/or webpages, which may include the health-related information and/or questionnaires. Administration of such documents may include notifying members in any suitable way of the availability and/or accessibility of such documents, and may provide an Internet address for accessing the documents.

Implementation of the disclosed system may be, to some extent, undertaken by hand. For example, the determination of which questions and/or information will be administered to individual members of the population and/or the assembly of questionnaires may be handled by one or more persons, e.g., managers or administrators of the system. It is contemplated, however, that either a manual, semi-computerized, or fully computerized implementation may be utilized.

### INDUSTRIAL APPLICABILITY

The present disclosure may be applicable to health and wellness fields. The present disclosure may have particular applicability in the healthcare industry. For example, the system may have widespread application in the insurance industry, within corporations trying to control costs, and for any group concerned with reducing costs of healthcare while improving the health and lifestyle of its members. Exemplary groups may include various types of organizations, such as companies, corporations, governments, government organizations, military organizations, educational institutions, etc.

The present disclosure may provide a way to significantly reduce costs associated with healthcare by selecting treatment interventions in an analytical manner at an early stage of disease development in order to reduce trial and error. For example, by analyzing a collection of information about an individual, system 110 may determine the level of risk that the individual has of developing particular health conditions. When the earliest symptoms appear, system 110 may be configured to select treatment interventions based on the likelihood that the symptoms are caused by certain health conditions for which the individual may be at risk. The selection of treatment interventions may be focused in any number of ways (e.g., severity, priority, cost, treatability, etc.), and may be generated in response to particular types of information stored in memory 160, such as demographics, insurance claims information, pharmacy information, etc.

An exemplary method of healthcare management utilizing system 110 may include selecting a first treatment intervention for addressing predetermined symptoms of an individual member of the population from two or more potential treatment interventions. The method may include selecting the first treatment based on a determined risk that the symptoms are caused by one or more predetermined health conditions. The method may also include selecting the first treatment intervention based on a success rate of each potential treatment intervention at treating the one or more predetermined health conditions and/or a cost of each potential treatment intervention.

An exemplary method of health management may also include prioritizing the cost of each potential treatment intervention and the success rate of each potential treatment intervention relative to one another. The method may also include selecting a second treatment intervention from the two or more potential treatment interventions. Such selecting may be based on the determined risk, the cost, and the success rate, wherein the cost and the success rate of each potential treatment intervention are prioritized differently than for selection of the first treatment intervention.

The method may further include selecting a preventative intervention from two or more potential preventative interventions to address one or more health conditions prior to detection of any symptoms of the one or more health conditions in the individual member. Such selecting may be based on information stored in memory 160. This information may include a determined risk that the individual member may experience at least one of the one or more health conditions. In addition, this information may include a success rate of each potential preventative intervention at treating the one or more health conditions and/or a cost of each potential preventative intervention.

The method may also include providing information regarding the first treatment intervention, the second treatment intervention and one or more preventative interventions to at least one of a healthcare provider and an insurer of the individual member.

It will be apparent to those having ordinary skill in the art that various modifications and variations can be made to the disclosed healthcare management system without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. A healthcare management system, comprising:
a memory configured to store health-related information about individual members of a population; and
a processor operatively coupled to the memory and configured to:
select a first treatment intervention for addressing predetermined symptoms of an individual member of the population from two or more potential treatment interventions, based on the following information stored in the memory:
a determined risk that the symptoms are caused by one or more predetermined health conditions; and at least one of the following factors:
a success rate of each potential treatment intervention at treating the one or more predetermined health conditions; and
a cost of each potential treatment intervention; and
an output module configured to provide information regarding the first treatment intervention to at least one of a healthcare provider and an insurer of the individual member.

2. The system of claim 1, wherein the processor is further configured to select the first treatment intervention based on both the success rate and the cost.

3. The system of claim 2, wherein the processor is further configured to prioritize the cost of each potential treatment intervention over the success rate.

4. The system of claim 2, wherein the processor is further configured to prioritize the success rate of each potential treatment intervention over the cost.

5. The system of claim 2, wherein the processor is further configured to prioritize the cost and the success rate relative to one another for selection of the first treatment intervention, and select a second treatment intervention from the two or more potential treatment interventions based on the determined risk, the cost, and the success rate, wherein the cost and the success rate of each potential treatment intervention are prioritized differently than for selection of the first treatment intervention.

6. The system of claim 1, wherein the information stored in the memory includes at least one of the following:
demographics;
medical records; and
pharmacy information.

7. The system of claim 1, wherein the processor is further configured to select a preventative intervention from two or more potential preventative interventions to address one or more health conditions prior to detection of any symptoms of the one or more health conditions in the individual member.

8. The system of claim 7, wherein the processor is further configured to select the preventative intervention based on the following information stored in the memory:
a determined risk that the individual member may experience at least one of the one or more health conditions and at least one of the following factors:
a success rate of each potential preventative intervention at treating the one or more health conditions; and
a cost of each potential preventative intervention.

9. The system of claim 8, wherein the output module is further configured to provide information regarding the selected preventative intervention to at least one of a healthcare provider and an insurer of the individual member.

10. A method of healthcare management, comprising:
selecting a first treatment intervention for addressing predetermined symptoms of an individual member of the population from two or more potential treatment interventions, based on the following information stored in a memory:
a determined risk that the symptoms are caused by one or more predetermined health conditions; and at least one of the following factors:
a success rate of each potential treatment intervention at treating the one or more predetermined health conditions; and
a cost of each potential treatment intervention; and
providing information regarding the first treatment intervention to at least one of a healthcare provider and an insurer of the individual member.

11. The method of claim 10, further including selecting the first treatment intervention based on both the success rate and the cost.

12. The method of claim 11, further including prioritizing the cost of each potential treatment intervention over the success rate.

13. The method of claim 11, further including prioritizing the success rate of each potential treatment intervention over the cost.

14. The method of claim 11, further including prioritizing the cost and the success rate relative to one another for selection of the first treatment intervention; and
selecting a second treatment intervention from the two or more potential treatment interventions based on the determined risk, the cost, and the success rate, wherein the cost and the success rate of each potential treatment intervention are prioritized differently than for selection of the first treatment intervention.

15. The method of claim 10, wherein the information stored in the memory includes at least one of the following:
demographics;
medical records; and
pharmacy information.

16. The method of claim 10, further including selecting a preventative intervention from two or more potential preventative interventions to address one or more health conditions prior to detection of any symptoms of the one or more health conditions in the individual member.

17. The method of claim 16, further including selecting the preventative intervention based on the following information stored in the memory:
a determined risk that the individual member may experience at least one of the one or more health conditions and at least one of the following factors:
a success rate of each potential preventative intervention at treating the one or more health conditions; and
a cost of each potential preventative intervention.

18. The method of claim 17, further including providing information regarding the selected preventative intervention to at least one of a healthcare provider and an insurer of the individual member.

19. A computer-readable medium having stored thereon machine executable instructions for healthcare management, the instructions comprising the steps of:
selecting a first treatment intervention for addressing predetermined symptoms of an individual member of the population from two or more potential treatment interventions, based on the following information stored in a memory:
a determined risk that the symptoms are caused by one or more predetermined health conditions; and at least one of the following factors:
a success rate of each potential treatment intervention at treating the one or more predetermined health conditions; and
a cost of each potential treatment intervention; and
providing information regarding the first treatment intervention to at least one of a healthcare provider and an insurer of the individual member.

20. The computer-readable medium of claim 19, further including instructions for selecting the first treatment intervention based on both the success rate and the cost.

21. The computer-readable medium of claim 20, further including instructions for prioritizing the cost of each potential treatment intervention and the success rate of each potential treatment intervention relative to one another.

22. The computer-readable medium of claim 20, further including instructions for prioritizing the cost and the success rate relative to one another for selection of the first treatment intervention; and
selecting a second treatment intervention from the two or more potential treatment interventions based on the determined risk, the cost, and the success rate, wherein the cost and the success rate of each potential treatment intervention are prioritized differently than for selection of the first treatment intervention.

23. The computer-readable medium of claim 19, wherein the information stored in the memory includes at least one of the following:
demographics;
medical records; and
pharmacy information.

24. The computer-readable medium of claim 19, further including instructions for selecting a preventative intervention from two or more potential preventative interventions to address one or more health conditions prior to detection of any symptoms of the one or more health conditions in the individual member based on the following information stored in the memory:
a determined risk that the individual member may experience at least one of the one or more health conditions and at least one of the following factors:
a success rate of each potential preventative intervention at treating the one or more health conditions; and
a cost of each potential preventative intervention.

25. The computer-readable medium of claim 24, further including instructions for providing information regarding the selected preventative intervention to at least one of a healthcare provider and an insurer of the individual member.
